(19) United States
(12) Patent Application Publication
(10) Pub. No.: US 2008/0239219 A1
(43) Pub. Date: Oct. 2, 2008

(54) TRANSFLECTIVE LIQUID CRYSTAL DISPLAY DEVICE

(75) Inventors: Shingo NAGANO, Tokyo (JP); Yuichi Masutani, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/054,869

(22) Filed: Mar. 25, 2008

(30) Foreign Application Priority Data
Mar. 26, 2007 (JP) 2007-078561

(51) Int. Cl. G02F 1/1335

(52) U.S. Cl. 349/114

(57) ABSTRACT

A transflective liquid crystal display device comprising: a first substrate; a second substrate having an opposing electrode; and a liquid crystal layer; wherein the first substrate includes: gate wires; source wires that cross the gate wires in plan view; a reflective pixel electrode that is formed apart from the source wires by a predetermined region in a reflective region, the reflective region is a part of a unit pixel region partitioned by the gate wires and the source wires; and a reflective contrast reduction preventing electrode formed above the reflective pixel electrode in the predetermined region, and the reflective contrast reduction preventing electrode having a region overlapping with the reflective pixel electrode in plan view; and wherein the reflective contrast reduction preventing electrode is connected to the reflective pixel electrode; and the reflective pixel electrode includes a constricted part in close proximity to the contact hole in plan view.

### CROSS REFERENCE TO RELATED APPLICATION

The present application claims priority from Japanese Patent Application No. 2007-078561, which was filed on Mar. 26, 2007, the disclosure of which is herein incorporated by reference in its entirety.

### TECHNICAL FIELD

The present invention relates to a liquid crystal display device and in particular to a liquid crystal display device capable of providing transmissive display and reflective display.

### BACKGROUND

In recent years, liquid crystal display devices have been used as representative display devices that have a low-profile and lightweight design as well as low power consumption. As a mobile device, transflective liquid crystal display devices, which are used indoor and outdoor, have been put on the market.

In a normally white mode transflective liquid crystal display device disclosed in Patent Reference 1, the pattern of a reflective contrast reduction preventing electrode is provided in the top layer of the reflective region. A reflective contrast reduction preventing electrode is arranged between the source wires and reflective pixel electrode in the reflective region. According to this configuration, a voltage is applied between the reflective contrast reduction preventing electrode and an opposing electrode on an opposing substrate, thus preventing unwanted reflected light from an auxiliary capacity electrode located in a space between the source wires and the reflective pixel electrode from being emitted onto a display surface and preventing lowering of reflection contrast. As a result, a display quality with high reflection contrast is obtained.

In a general transflective liquid crystal display device, in order to set the optical distance of passing through a liquid crystal nearly the same in the reflective region and transmissive region, the thickness of the liquid crystal display in the reflective region is about half that in the transmissive region. According to this configuration, a pixel defect, in which a short circuit occurs between a reflective contrast reduction preventing electrode arranged in a reflective region and an opposed electrode on an opposed substrate, is occurred due to conductive foreign substances mixed into a liquid crystal layer.

As a method for repairing such a pixel defect, there is disclosed, in Patent Reference 2, a method for electrically separating the reflective contrast reduction preventing electrode from the transmissive pixel electrode by cutting the transparent conductive film pattern of the reflective contrast reduction preventing electrode with laser light, in the space between the transparent conductive film pattern of the reflective contrast reduction preventing electrode and the transmissive pixel electrode.

### [Patent Reference 1] Japanese Patent Application No. 2004-260873 (JP-A-2006-78643)

### [Patent Reference 2] JP-A-2007-10738

### SUMMARY

In the embodiment for repairing a pixel detect disclosed in Patent Reference 2, the reflective contrast reduction preventing electrode to be cut with laser light is a transparent conductive film that transmits nearly the entire laser radiation. Thus, fusion caused by absorption of heat is hard to occur and it is difficult to cut the transparent conductive film. When laser of higher energy is irradiated, the target transparent conductive film is scattered into the surrounding atmosphere to form conductive foreign substances thus inducing a new pixel defect.

The invention has been accomplished to solve the problems. An object of the invention is to provide a transflective liquid crystal display device including a reflective contrast reduction preventing electrode, the transflective liquid crystal display device capable of electrically separating the reflective contrast reduction preventing electrode from a pixel electrode with ease by way of laser repair.

A transflective liquid crystal display device according to the first aspect of the present invention comprises: a first substrate; a second substrate disposed opposite to the first substrate and having an opposing electrode; and a liquid crystal layer enclosed between the first substrate and the second substrate; wherein the first substrate includes: a plurality of gate wires formed on the first substrate; a plurality of source wires formed on the first substrate, the source wires that cross the gate wires in plan view; a reflective pixel electrode that is disposed on the same layer as the source wires, the reflective pixel electrode that is formed apart from the source wires by a predetermined region in a reflective region, the reflective region is a part of a unit pixel region partitioned by the gate wires and the source wires; and a reflective contrast reduction preventing electrode formed above the reflective pixel electrode in the predetermined region, and the reflective contrast reduction preventing electrode having a region overlapping with the reflective pixel electrode in plan view via an insulating film; and wherein the reflective contrast reduction preventing electrode is connected to the reflective pixel electrode via a contact hole provided in the insulating film; and the reflective pixel electrode includes a constricted part in close proximity to the contact hole in plan view.

According to the first aspect of the present invention, it is possible to obtain a transflective display device capable of readily performing laser-repair of a pixel detect caused by a short circuit between an opposing electrode and a reflective contrast reduction preventing electrode.

### BRIEF DESCRIPTION OF THE DRAWINGS

Illustrative aspects of the invention will be described in detail with reference to the following figures wherein:

FIG. 1 is a plan view of an array substrate of the transflective liquid crystal display device according to the first exemplary embodiment of the present invention;

FIG. 2 is a cross-sectional view of the array substrate of the transflective liquid crystal display device according to the first exemplary embodiment of the present invention;

FIG. 3 is a cross-sectional view illustrating a method for manufacturing an array substrate of the transflective liquid crystal display device according to the first exemplary embodiment of the present invention;

FIG. 4 is a plan view illustrating a method for manufacturing an array substrate of the transflective liquid crystal display device according to the first exemplary embodiment 1 of the present invention;

FIG. 5 is an enlarged plan view of the section D of FIG. 1; and

FIG. 6 is a cross-sectional view of the section D taken along the arrowed line P-P in FIG. 5 including an opposing substrate.

### DETAILED DESCRIPTION OF THE PREFERRED EMBODIMENTS

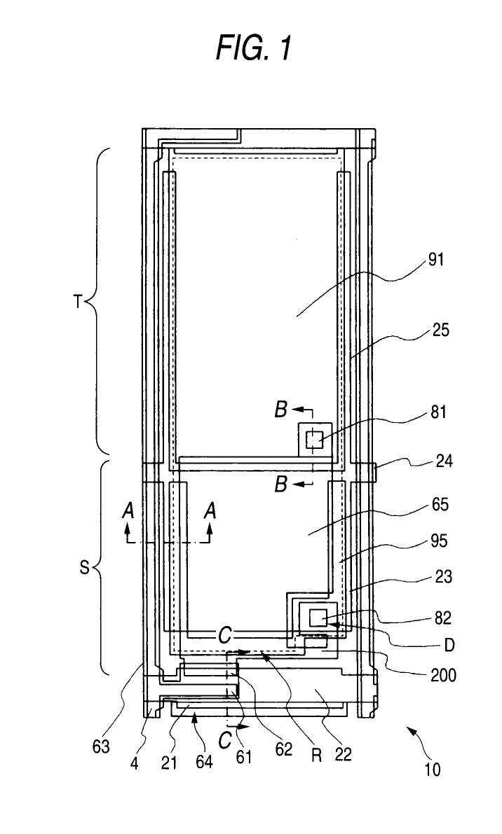

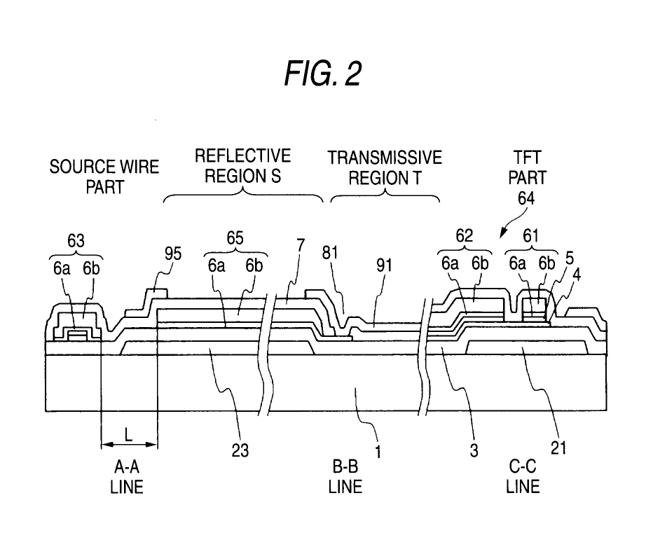

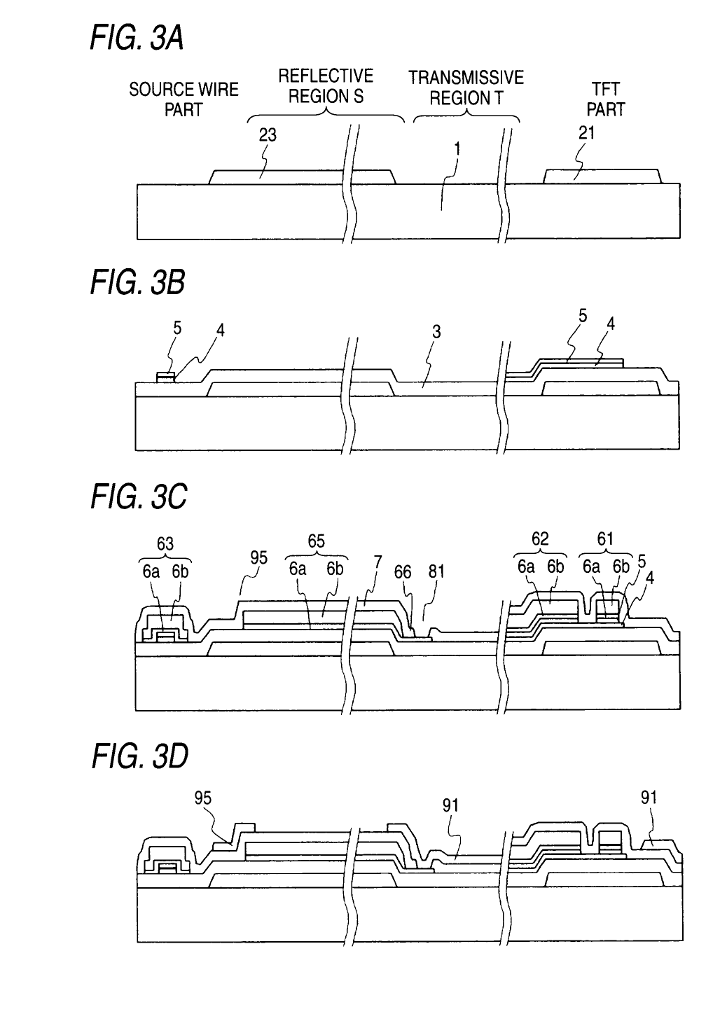

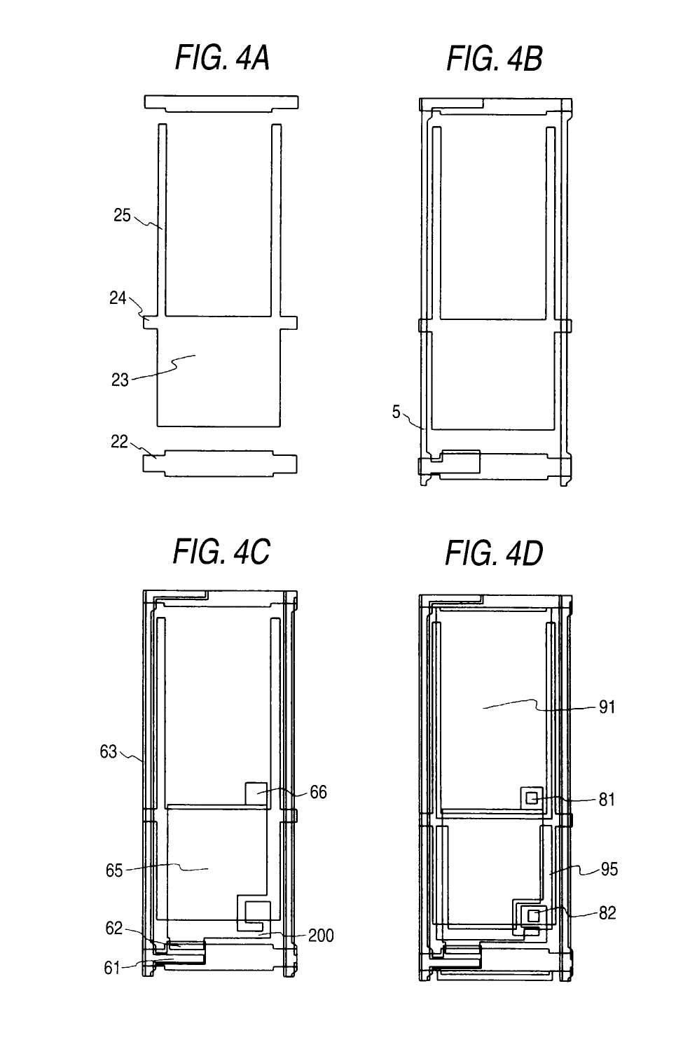

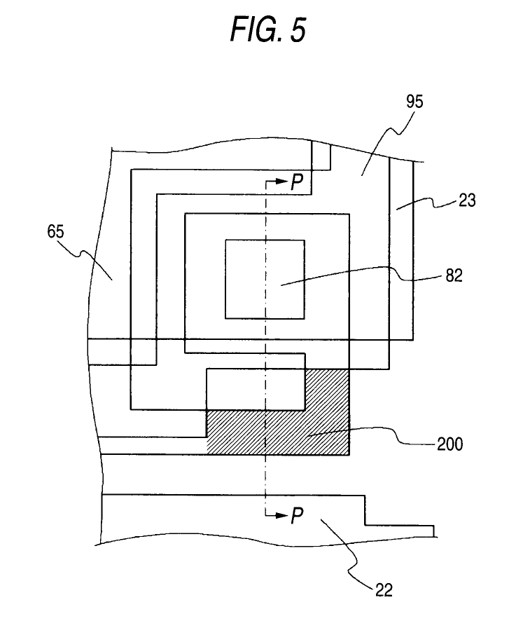

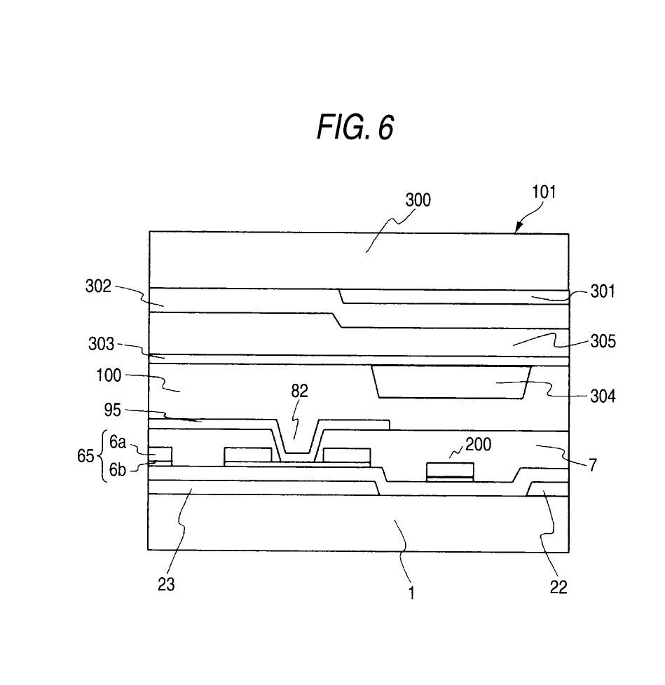

FIG. 1 is a plan view of an array substrate of a transflective liquid crystal display device according to the first exemplary embodiment of the present invention. FIG. 2 shows cross-sections of the array substrate shown in FIG. 1 taken along the arrowed line A-A (source wires and a reflective region S), the arrowed line B-B (a connection part of the reflective region S and the transmissive region T), and the arrowed line C-C (a TFT part). FIG. 3 is a cross-sectional view illustrating a method for manufacturing an array substrate of the transflective liquid crystal display device according to the first exemplary embodiment of the present invention. FIG. 4 is a plan view illustrating a method for manufacturing an array substrate of the transflective liquid crystal display device according to the first exemplary embodiment of the present invention. FIG. 5 is an enlarged plan view of the section D of FIG. 1. FIG. 6 is a cross-sectional view of the section D taken along the arrowed line P-P including an opposing substrate.

Referring to FIGS. 1 and 2, each pixel, which is disposed on an array substrate 10, comprises a transmissive region T to transmit light and a reflective region S to reflect ambient light entering a liquid crystal layer 100.

On a transparent insulating substrate 1 such as a glass substrate, gate wires 22 including a gate electrode 21 made of a first conductive film, and auxiliary capacity wiring 24 including a first auxiliary capacity electrode 23 and a second auxiliary capacity electrode 25 are formed, in order to prevent leakage light from the backlight and retain a voltage for a prespecified period. Above the gate wires 22 and the auxiliary capacity wiring 24, a first insulating film 3 as a gate insulating layer is formed. On the gate electrode 21, a semiconductor active film 4 as a semiconductor layer and an ohmic contact film 5 are formed via the first insulating film 3. The ohmic contact film 5 has its central part removed and is divided into two regions. On one region and the other region, a source electrode 61 composed of a second conductive film and a drain electrode 62 composed of the same second conductive film are respectively laminated. The semiconductor active film 4, the source electrode 61 and the drain electrode 62 constitute a TFT 64 as a switching element.

Source wires 63 extending from the source electrode 61 are arranged to cross the gate wires 22 via the first insulating film 3. On the intersection parts and the source wires 63, the semiconductor active film 4 and the ohmic contact film 5 are remained in order to enhance the withstand voltage.

The reflective region S is formed by a reflective pixel electrode 65 extending from the drain electrode 62. In other words, the reflective pixel electrode 65 is formed by the second conductive film. Thus, the second conductive film uses a thin film including a metallic film with high reflectivity at least in its surface layer. In order to prevent a defect caused by a short circuit between the reflective pixel electrode 65 and the source wires 63, the reflective pixel electrode 65 is disposed apart from the source wires 63 by a predetermined spacing L of preferably 5 μm to 10 μm.

A second insulating film 7 is arranged to cover the above components. A portion of the second insulating film 7 on the reflective pixel electrode 65 is removed to form a contact hole 81. Above the second insulating film 7 and the contact hole 81, a transmissive pixel electrode 91 made of a transparent conductive film is formed in order to form a transmissive region T. The transmissive pixel electrode 91 is electrically connected to the reflective pixel electrode 65 via the contact hole 81 and electrically connected to the drain electrode 62 via the reflective pixel electrode 65.

Above the spacing L between the reflective pixel electrode 65 and the source wires 63, a reflective contrast reduction preventing electrode 95, which is made of a transparent conductive film, is disposed via the second insulating film 7. The reflective contrast reduction preventing electrode 95 is formed almost in parallel with the source wires 63 so as to lie along the source wires 63. The reflective contrast reduction preventing electrode 95 is connected to the reflective pixel electrode 65 via the contact hole 82. The reflective contrast reduction preventing electrode 95 is a member designed to apply an electric field to a liquid crystal layer 100 that is disposed above the spacing between the source wires 63 and the reflective pixel electrode 65. It is possible to prevent lowering of the reflection contrast in the normally white mode by forming the reflective contrast reduction preventing electrode 95.

The reflective contrast reduction preventing electrode 95 is formed in the same layer as the transmissive pixel electrode 91 and thus a new manufacturing process is not required, the reflective contrast reduction preventing electrode 95 may be separately formed by another conductive film.

In the section D of FIGS. 1 and 5, a constricted part 200 is arranged on the reflective pixel electrode 65 in close proximity to the contact hole 82, and the auxiliary capacity electrode 23 is not arranged below the constricted part 200. The reflective contrast reduction preventing electrode 95 is not arranged above the constricted part 200.

In case a short circuit has occurred between the reflective contrast reduction preventing electrode 95 and an opposing electrode 303 due to conductive foreign substances present in the liquid crystal layer 100, the reflective pixel electrode 65 and the transmissive pixel electrode 91 are brought at the potential of the opposing electrode 303 and no voltage is applied to the liquid crystal layer 100, thus resulting in a pixel defect. To repair the defect, the constricted part 200 is cut with laser light and the reflective contrast reduction preventing electrode 95 is electrically separated from the reflective pixel electrode 65 on the side of the drain electrode 62.

That is, the reflective contrast reduction preventing electrode 95, which short-circuited with the opposing electrode 303 on the opposing substrate 101, is electrically separated from the reflective pixel electrode 65 on the side of the drain electrode 62 and has no electrical influence on the reflective pixel electrode 65 and the transmissive pixel electrode 91, which allows a pixel defect to be repaired.

Next, a process of manufacturing an array substrate of the transflective liquid crystal display device according to the first exemplary embodiment will be described referring to FIGS. 3 and 4.

As shown in FIG. 3A and FIG. 4A, a transparent insulating substrate 1 such as a glass substrate is cleaned to purify its surface. A first conductive film is formed on the transparent insulating substrate 1 by way of the sputtering method, followed by patterning. The first conductive film may use a thin film made of an alloy whose main components are chrome (Cr), molybdenum (Mo), tantalum (Ta), titanium (Ti) and aluminum (Al). In the first exemplary embodiment, a chrome film 400 nm thick is formed as a first conductive film.

On the first conductive film, a contact hole 81 is formed by way of dry etching in a process described later, and a conductive thin film (transparent conductive film) for obtaining electric connection is formed in the contact hole 81. Thus, it is preferable to use, as a first conductive film, a metallic thin film resistant to surface oxidation or a metallic thin film that retains conductivity even when oxidized. In case an Al-based material is used as a first conductive film, an aluminum nitride film, or a film made of Cr, Mo, Ta, or Ti should be formed on the surface in order to prevent degradation of conductivity due to surface oxidation.

Next, in a first photo-engraving process, a first conductive film is patterned to form a gate electrode 21, gate wires 22, a first auxiliary capacity electrode 23 and an auxiliary capacity electrode 24, and a second auxiliary capacity electrode 25. The first auxiliary capacity electrode 23 is formed on the almost entire surface of the reflective region S. The second auxiliary capacity electrode 25 is formed so as to lie in parallel with the source wires 63 described later. The photo-engraving process is as follows: a substrate is cleaned and a photosensitive resist is applied to the substrate and the substrate is dried; then, the substrate is exposed through a mask where a predetermined pattern is formed, followed by development; this forms a resist having a mask pattern transferred thereto on the substrate; the photosensitive resist is heated and cured, followed by etching of the first conductive film; then the photosensitive resist is peeled off.

Etching of the first conductive film may be performed by way of the wet etching method using a known etchant. For example, in case the first conductive film is made of chrome, a solution of a mixture of second cerium nitrate ammonium and nitric acid is used. In the etching of the first conductive film, it is preferable to perform taper etching in which a pattern edge section having a trapezoidal taper shape is obtained, in order to enhance the coverage of an insulating film at the stepped part of a pattern edge thus preventing a short circuit at a stepped part to other wiring.

Next, as shown in FIG. 3B and FIG. 4B, a first insulating film 3, a semiconductor active film 4, and an ohmic contact film 5 are successively formed by way of the plasma CVD method and then patterning is performed. As a first insulating film 3 serving as a gate insulating film, a single-layer film, for example, any one of an SiNx film, SiOy film, and SiOzNw film or a multi-layer film made of a laminate of these is used (x, y, z and w are positive numbers representing a stoichiometric composition). In case the thickness of the first insulating film is insufficient, a short circuit is likely to occur at the intersection parts of the gate wires 22 and the source wires 63. In case the thickness is excessive, the ON current of the TFT is small and the display characteristics will drop. Thus, the thickness of the first insulating film is necessarily greater than that of the first conductive film but is preferably as small as possible. The first insulating film 3 is preferably formed in multiple steps in order to prevent any short circuit caused by a pin hole. In the first exemplary embodiment, an SiNx film 300 nm thick is formed and then an SiNx film 100 nm thick is formed. Thus, an SiNx film 400 nm thick is formed as a first insulating film 3.

As a semiconductor active film 4, an amorphous silicon (a-Si) film or a polysilicon (p-Si) film is used. In case the thickness of the semiconductor active film 4 is insufficient, the film disappears in dry etching of an ohmic contact film 5 described later. In case the thickness of the semiconductor active film 4 is excessive, the ON current of the TFT is small. Thus, the thickness of the semiconductor active film 4 must be determined in consideration of the controllability of etching amount in dry etching of the ohmic contact film 5 and the necessary ON current value of TFT. In the first exemplary embodiment, an a-Si film 150 nm thick is formed as a semiconductor active film 4.

As an ohmic contact film 5, an n-type a-Si film or n-type p-Si film where a small amount of phosphorus (P) is doped therein is used. In the first exemplary embodiment, an n-type a-Si film 30 nm thick is formed as an ohmic contact film 5.

Next, in a second photo-engraving process, the semiconductor active film 4 and the ohmic contact film 5 are patterned so that those films will remain at least in a portion where the TFT part is formed. The semiconductor active film 4 and the ohmic contact film 5 may remain in portions where the gate wires 22 cross the source wires 63 and portions where the source wires 63 are formed in order to increase the withstand voltage. Etching of the semiconductor active film 4 and the ohmic contact film 5 may be performed by way of the dry etching method using a known gas composition (for example, a gas mixture of SF₆ and O₂ or CF₄ and O₂).

Next, as shown in FIG. 3C and FIG. 4C, a second conductive film is formed by way of the sputtering method and patterning is made. A second conductive film is formed with thin films serving as a first layer and a second layer described below. For example, Cr, Mo, Ta, Ti or an alloy of a combination of these metals as main components is used to form a thin film of a first layer 6a. Al, silver (Ag) or an alloy of a combination of these metals as main components is used to form a thin film of a second layer 6b. The first layer 6a is formed on the ohmic contact layer S and the first insulating layer 3 in direct contact with these layers. The second layer 6b is formed on the first layer 6a in direct contact with the first layer 6a. The second conductive film is used as source wires 63 and a reflective pixel electrode 65, so that it is necessary to form the second conductive film in consideration of the wiring resistance and the reflective characteristics of the surface layer. In the first exemplary embodiment, a Cr film 100 nm thick is formed as a first layer 6a of the second conductive film and an AlCu film 300 nm thick is formed as a second layer 6b thereof.

Next, in a third photo-engraving process, the second conductive film is patterned to form source wires 63 including a source electrode 61 and a reflective pixel electrode 65 including a drain electrode 62. The drain electrode 62 and the reflective pixel electrode 65 are formed in succession in the same layer so that electric connection is established between the drain electrode 62 and the reflective pixel electrode 65 in the same layer. A constricted part 200 is provided on the reflective pixel electrode 65. Etching of the second conductive film may be performed by way of the wet etching method using a known etchant.

Next, the central part of the ohmic contact film 5 in the TFT part is etched and removed to expose a semiconductor active film 4. Etching of the ohmic contact film 5 may be performed by way of the dry etching method using a known gas composition (for example, a gas mixture of SF₆ and O₂ or CF₄ and O₂).

The second layer 6b formed by AlCu in a part where a contact hole 81 is formed is removed to form a contact area 66. The contact area 66 may be formed by performing exposure using the halftone exposure method so as to provide a small thickness of the photoresist layer of the removal part and by removing only the resist in the removal part through film reduction of the resist using oxygen plasma after dry etching of the ohmic contact film 5 and then performing wet etching of AlCu in the third photo-engraving process. Thereby, the surface of the second conductive film contacting with the transparent conductive film becomes Cr of the first layer 6a, and as a result, the contact having a good conductivity is obtained.

The halftone exposure process is described below. In halftone exposure, the residual film thickness of a photoresist is controlled by adjusting the exposure intensity by way of exposure via a halftone mask. For example, the halftone mask is a mask having a dark/bright Cr pattern. After that, etching of a film is made in a portion where the photoresist is completely removed. Next, the photoresist is reduced using oxygen plasma to remove the photoresist in a portion where a small amount of film thickness is left. Then, etching of a film is made in a portion where a small amount of residual film thickness of the photoresist is left (the photoresist is removed). This enables patterning of two processes in a single photo-engraving process.

In case an aluminum nitride alloy (AlCuN) is formed on the surface of the second conductive film, the reflectivity is somewhat lowered but a good contact with the transparent conductive film 91 described later is obtained. It is thus possible to omit a process of forming the contact area 66.

Next, the second insulating film 7 is formed by the plasma CVD method. The second insulating film 7 may be formed by the same material of first insulating film 3. The film thickness is preferably determined in consideration of the coverage of the lower layer pattern. In the first exemplary embodiment, an SiNx film 500 nm thick is formed as a second insulating film 7.

Next, in a fourth photo-engraving process, the second insulating film 7 is patterned to form contact holes 81, 82 on the reflective pixel electrode 65. Etching of the second insulating film 7 may be performed by way of the wet etching method using a known etchant, or by way of the dry etching method using a known gas composition.

Next, as shown in FIG. 3D and FIG. 4D, a transparent conductive film is formed by way of the sputtering method, followed by patterning. ITO or SnO₂ may be used as a transparent conductive film. In particular, ITO is preferably used from the standpoint of chemical stability. ITO may be crystallized ITO or amorphous ITO (a-ITO). In case a-ITO is used, it is necessary to crystallize a-ITO above the crystallization temperature of 180 degrees after patterning. In the first exemplary embodiment, an a-ITO film 80 nm thick is formed as a transparent conductive film.

Next, in a fifth photo-engraving process, the transparent conductive film is patterned and a transmissive pixel electrode 91 is formed in a transmissive region T. Considering displacement in patterning, the transmissive pixel electrode 91 is formed to partially overlap the reflective pixel electrode 65 via a second insulating film 7 in a boundary region of the reflective region S and the transmissive region T. The transmissive pixel electrode 91 is electrically connected to the reflective pixel electrode 65 via the contact hole 81.

A reflective contrast reduction preventing electrode 95 for preventing lowering of the reflection contrast is formed with a transparent conductive film above the spacing L between the reflective pixel electrode 65 and the source wires 63 via the second insulating film 7. The reflective contrast reduction preventing electrode 95 is formed almost in parallel with the source wires 63 in a position overlapping the first auxiliary capacity electrode 23 along the source wires 63. The reflective contrast reduction preventing electrode 95 is electrically connected to the reflective pixel electrode 65 in close proximity to the constricted part 200 via the contact hole 82.

While the reflective contrast reduction preventing electrode 95 is formed of the same layer as the transmissive pixel electrode 91, the reflective contrast reduction preventing electrode 95 is separated from the transmissive pixel electrode 91 in plan view. The reflective contrast reduction preventing electrode 95 is arranged elsewhere than above the constricted part 200 of the reflective pixel electrode 65.

The reflective contrast reduction preventing electrode 95 is formed up to a location at least overlapping the end of the source wires 63 of the reflective pixel electrode 65 and overlapping a boundary R where the black matrix (light shielding film) 301 of the opposing electrode 101 is disposed.

An array substrate 10 thus formed has an orientation film applied thereon in the subsequent cell-making process, followed by rubbing in a predetermined direction. Similarly, an opposing substrate 101 opposite to the array substrate 10 includes a black matrix 301 surrounding a pixel region on a transparent insulating substrate 300 and forms a color filter 302 in the surrounded region. Above the color filter 302 an opposing electrode 303 is disposed, on which an orientation film is applied and rubbing is performed. The array substrate 10 and the opposing substrate 101 are overlaid one on the other via a spacer so that respective orientation films are opposed to each other. The peripheral edges of both substrates are bonded together with a sealing material and liquid crystal is enclosed between both substrates. Deflection plates are bonded to both surfaces of a liquid crystal cell thus formed. A backlight unit is mounted on the rear surface of the liquid crystal cell to complete a transflective liquid crystal display device.

In the region of the opposing substrate 101 opposite to the reflective region S of the array substrate 10, a transparent resin film 305 is formed on the color filter 302. The thickness of the liquid crystal layer 100 in the reflective region S is about half that of the transmissive region T.

Next, details of laser repair will be described. As shown in FIG. 5, a constricted part 200 is provided on the reflective pixel electrode 65 in close proximity to the contact hole 82. In the first exemplary embodiment, as shown by a shaded part, an auxiliary capacity electrode 23 is not arranged below the constricted part 200. A reflective contrast reduction preventing electrode 95 is not arranged above the constricted part 200.

In case a short circuit has occurred between the reflective contrast reduction preventing electrode 95 and the opposing electrode 303 due to conductive foreign substances mixed into the liquid crystal layer 100, it is possible to electrically separate the reflective contrast reduction preventing electrode 95 from the reflective pixel electrode 65 on the side of the drain electrode 62 by cutting the constricted part 200 (shaded region in FIG. 5) of the reflective pixel electrode 65 with laser light. As a result, the short circuit does not influence the reflective pixel electrode 65 and the transmissive pixel electrode 91 and a voltage is successfully applied to the liquid crystal layer 100 and a pixel defect is repaired.

The constricted part 200 is formed by the metallic film of the reflective pixel electrode 65 so that it is technically easy to cut the constricted part 200 with laser light, and the cutting width of the constricted part 200 is as small as 5 μm to 10 μm. This is advantageous in terms of mass productivity.

The auxiliary capacity electrode 23 is not arranged below the constricted part 200. Laser radiation is possible from the rear surface of the transparent insulating substrate 1. The laser does not cut the auxiliary capacity electrode 23 thus preventing another short circuit caused by laser repair between the auxiliary capacity electrode 23 and the reflective pixel electrode 65.

The reflective contrast reduction preventing electrode 95 is not arranged above the constricted part 200. The laser does not cut the reflective contrast reduction preventing electrode 95 thus preventing another short circuit caused by laser repair between the reflective contrast reduction preventing electrode 95 and the reflective pixel electrode 65.

As shown in FIG. 6, a black matrix 301 is arranged in the region of the opposing electrode 101 opposite to the constricted part 200. The black matrix 301 shields light leaking from a gap located near the constricted part 200 as well as light leaking from the cutting portion of the constricted part after laser repair.

In the first exemplary embodiment, a thick film projection 304 made of an insulating resin is provided to cover the opposing electrode 303 in the region of the opposing electrode 101 opposite to the constricted part 200. Although this projection 304 is not essential, the film thickness is preferably 1 μm or more, which will suppress deformation of the metallic film of the reflective pixel electrode 65 or dispersion of scattered materials often encountered in laser repair, thus preventing another short circuit with the opposing electrode 303. It is thus possible to enhance the success rate of laser repair and reliability of pixels after laser repair.

The projection 304 does not come into contact with the opposing array substrate 10 in FIG. 6 although the projection 304 may be brought into contact with the array substrate 10 to use the projection 304 as a column spacer to specify the thickness of the liquid crystal layer 100.

As described above, a transflective liquid crystal display device according to the present invention includes a constricted part 200 in close proximity to a contact hole 82 connecting a reflective contrast reduction preventing electrode 95 and a reflective pixel electrode 65. It is thus made easy to cut the reflective pixel electrode 65 of the constricted part 200 with laser repair even in case a short circuit has occurred between the reflective contrast reduction preventing electrode 95 and an opposing electrode 195 thus resulting in a pixel defect. It is possible to electrically separate the reflective contrast reduction preventing electrode 95 from the reflective pixel electrode 65. It is thus possible to obtain a transflective liquid crystal display device capable of repairing a pixel defect.

What is claimed is:

1. A transflective liquid crystal display device comprising:
a first substrate;
a second substrate disposed opposite to the first substrate and having an opposing electrode; and
a liquid crystal layer enclosed between the first substrate and the second substrate; wherein
the first substrate includes:
a plurality of gate wires formed on the first substrate;
a plurality of source wires formed on the first substrate, the source wires that cross the gate wires in plan view;
a reflective pixel electrode that is disposed on the same layer as the source wires, the reflective pixel electrode that is formed apart from the source wires by a predetermined region in a reflective region, the reflective region is a part of a unit pixel region partitioned by the gate wires and the source wires; and
a reflective contrast reduction preventing electrode formed above the reflective pixel electrode in the predetermined region, and the reflective contrast reduction preventing electrode having a region overlapping with the reflective pixel electrode in plan view via an insulating film; and wherein
the reflective contrast reduction preventing electrode is connected to the reflective pixel electrode via a contact hole provided in the insulating film; and
the reflective pixel electrode includes a constricted part in close proximity to the contact hole in plan view.

2. The transflective liquid crystal display device according to claim 1, wherein
the reflective contrast reduction preventing electrode is not disposed above the constricted part.

3. The transflective liquid crystal display device according to claim 1,
wherein a common electrode forming an auxiliary capacity is not disposed below the constricted part.

4. The transflective liquid crystal display device according to claim 1, wherein
a light-shielding film is disposed in a region of an opposing substrate that is opposite to the constricted part.

5. The transflective liquid crystal display device according to claim 1, wherein
a projection that is made of an insulating resin is disposed in a region of an opposing substrate that is opposite to the constricted part.
